(19) United States
(12) Patent Application Publication
(10) Pub. No.: US 2007/0115494 A1
(43) Pub. Date: May 24, 2007

(54) Image processing system, information processing device, computer readable recording medium, and information processing method

(76) Inventor: Hidetomo Nakayama, Kawasaki-shi (JP)

Correspondence Address: GAUTHIER & CONNORS, LLP, 225 FRANKLIN STREET, SUITE 2300, BOSTON, MA, 02110, US

(21) Appl. No.: 11/442,919

(22) Filed: May 30, 2006

(30) Foreign Application Priority Data
Nov. 18, 2005 (JP) 2005-333720

(51) Int. Cl. G06K 15/00

(52) U.S. Cl. 358/1.14; 358/1.15

(57) ABSTRACT

An image processing system includes an image processing device that processes an image; an information registration unit that transmits to the image processing device confidential information, included in setting information used for issuing a job, and registers the confidential information therein; an information acquisition unit that, before issuing a job, requests the image processing device to send the registered confidential information and acquires the confidential information; and a job issuing unit that issues the job to the image processing device using the acquired confidential information.

### PRIORITY INFORMATION

This application claims priority to Japanese Patent Application No. 2005-333720, filed on Nov. 18, 2005, which is incorporated herein by reference in its entirety.

### BACKGROUND

1. Technical Field

The present invention relates to an image processing system.

2. Related Art

There has been known an image processing system that includes image processing devices, such as a printer, a facsimile, and a multi-function (MF) apparatus, and a personal computer (PC) that issues a job to those image processing devices.

In one known image processing system, the image processing device identifies a user on the basis of a user ID/password to perform output management or accounting for each user. A PC in this image processing system issues a job with a user ID/password attached. The image processing device authenticates the user by means of the user ID/password attached to the job and performs accounting for the authenticated user. In this system, although in some cases the user is requested to enter a user ID/password each time the user issues a job, most PCs hold a once-entered user ID/password in the internal non-volatile storage area to thereby eliminate the need for re-entry by the user.

In another known image processing system, the image processing device has a so-called “direct fax function”; that is, the image processing device does not print data but sends data directly to a facsimile in accordance with an instruction from the PC. In this system, although in some cases the user is requested to enter a destination number each time the user uses the direct fax function, most PCs hold the fax transmission destination information in an internal non-volatile storage area in advance and simply specify the destination number by reference to the fax destination information.

### SUMMARY

According to an aspect of the invention, there is provided an image processing system including: an image processing device that processes an image; an information registration unit that transmits confidential information, included in setting information used for issuing a job, to the image processing device and registers the confidential information therein; an information acquisition unit that, before issuing a job, requests the image processing device to send the registered confidential information and acquires the confidential information; and a job issuing unit that issues the job to the image processing device using the acquired confidential information.

### BRIEF DESCRIPTION OF THE DRAWINGS

Embodiments of this invention will be described in detail by reference to the following figures, wherein;

FIG. 1 is a diagram showing the general configuration of an image processing system in an embodiment;

FIG. 2 is a block diagram showing the functional configuration of an MF apparatus and a PC;

FIG. 3 is a diagram showing an operating procedure of the image processing system when information is registered;

FIG. 4 is a diagram showing an operating procedure of the image processing system when information is registered;

FIG. 5 is a diagram showing an operating procedure of the image processing system when account printing is performed;

FIG. 6 is a diagram showing an operating procedure of the image processing system when direct fax transmission is performed; and

FIG. 7 is a diagram showing an operating procedure of the image processing system when information is updated.

### DETAILED DESCRIPTION

Exemplary embodiments of this invention will be described hereinafter with reference to the attached drawings.

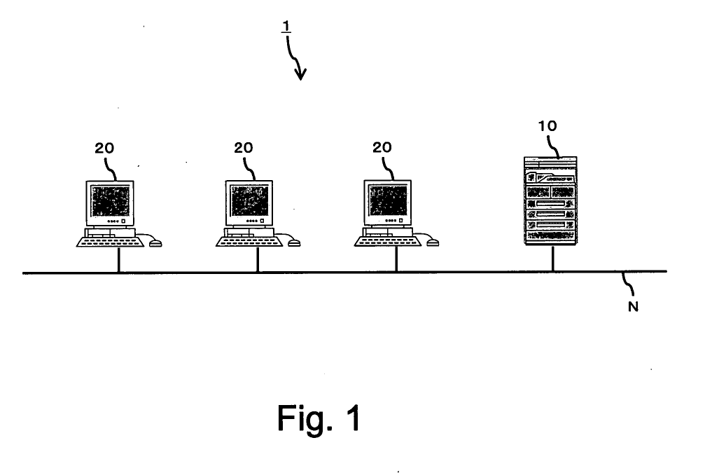

FIG. 1 is a diagram showing the general configuration of an image processing system 1 of this embodiment. As shown in FIG. 1, the image processing system 1 includes an image processing device 10, and one or more information processing devices 20 connected to the image processing device 10 via a network N. In this embodiment, the image processing device 10 has a printer function or a facsimile function. For example, the image processing device 10 is a multi-function (MF) apparatus having two or more of the printer function, a scanner function, a copy function, and the facsimile function. In this example, each of the information processing devices 20, which is a device issuing a job to the image processing device 10, is a PC. In the description below, the image processing device 10 is described as an MF apparatus 10, and each of the information processing devices 20 as a PC 20.

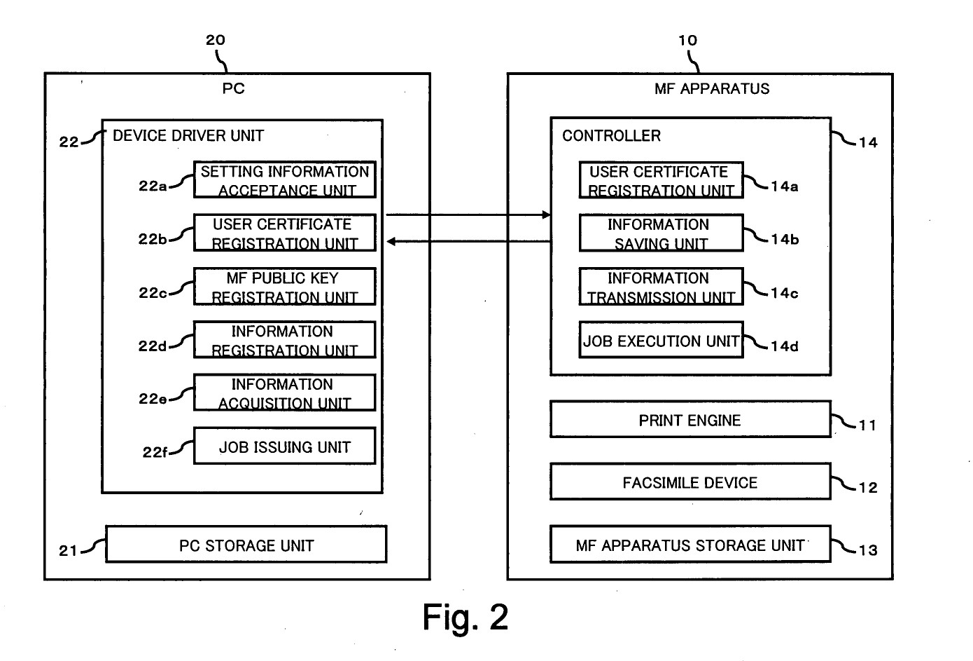

FIG. 2 is a block diagram showing the functional configuration of the MF apparatus 10 and that of the PC 20. The following describes the configuration of the MF apparatus 10 and that of the PC 20 with reference to FIG. 2.

The PC 20 is implementing by the combination of software and the hardware resources. In this embodiment, the software resources of the PC 20 include an operating system (OS), device drivers, and various application software programs; and the hardware resources of the PC 20 include a CPU (Central Processing Unit), ROM (Read Only Memory), RAM (Random Access Memory), a hard disk, input devices such as a keyboard and a mouse, and output devices such as a display.

The PC 20 has a PC storage unit 21 and a device driver unit 22. The PC storage unit 21 includes a volatile storage area allocated in the RAM, and a non-volatile storage area allocated on a hard disk. The device driver unit 22 is implemented by a computer program (a device driver in this example) executed by the CPU. The device driver unit 22 has a setting information acceptance unit 22a, a user certificate registration unit 22b, an MF public key registration unit 22c, an information registration unit 22d, an information acquisition unit 22e, and a job issuing unit 22f. To implement the functional blocks 22a-22f described above, it is of course possible for the device driver to use other software functions such as the OS. The computer program for implementing the functional blocks 22a-22f described above is not limited to the device driver, but other programs may also be used.

The setting information acceptance unit 22a accepts setting information used for issuing a job. More specifically, the setting information acceptance unit 22a accepts setting information for issuing a print job or a direct fax transmission job, on the basis of the user operation on the screen. The setting information includes confidential information such as personal management security information; for example, account-authentication user ID/password or fax transmission destination information, and other general information (IP address of the MF apparatus 10, device configuration information, etc.).

The user certificate registration unit 22b registers a user's public key certificate (hereinafter called “user certificate”) and a private key (hereinafter called a user private key). More specifically, on the basis of the user operation on the screen, the user certificate registration unit 22b registers a user certificate, issued by a certificate authority (for example, an official certificate authority), and a user private key, which forms a key pair with the user public key included in the user certificate, into the non-volatile storage area of the PC storage unit 21. Instead, the user certificate registration unit 22b may also store the certificate file and the private key file into the non-volatile storage area for the device driver or record information identifying the OS-managed certificate file and the private key file (for example, paths and file names of the files).

The MF public key registration unit 22c registers the public key of the MF apparatus 10 (hereinafter called “MF public key”). In this embodiment, the MF public key registration unit 22c communicates with the MF apparatus 10 via the network N to exchange the user certificate, which is registered by the user certificate registration unit 22b, and the MF public key, which is registered in the MF apparatus 10, and stores the MF public key, acquired through the exchange, into the non-volatile storage area of the PC storage unit 21. Note that the MF public key registration unit 22c can acquire the MF public key by some other method.

The information registration unit 22d associates the confidential information, included in the setting information accepted by the setting information acceptance unit 22a, with the user certificate, registered by the user certificate registration unit 22b, and transmits the associated confidential information to the MF apparatus 10 for registration. Before the transmission, the information registration unit 22d encrypts the confidential information by means of the MF public key, registered by the MF public key registration unit 22c, to prevent leakage of the confidential information. Transmitting the confidential information and the user certificate, which are associated with each other, means not only that the user certificate is transmitted with the confidential information, but also that the user certificate identifying information (hereinafter called “user certificate identification information”) is transmitted with the confidential information. In this embodiment, because the user certificate is already transmitted to the MF apparatus 10 by the MF public key registration unit 22c, the information registration unit 22d transmits the user certificate identification information with the confidential information. The user certificate identification information is, for example, a certificate serial number described in the user certificate.

Before issuing a job, the information acquisition unit 22e specifies a user certificate, registered by the user certificate registration unit 22b, to request the MF apparatus 10 to supply the confidential information registered as an entry associated with the user certificate. The user certificate is specified, for example, by providing the user certificate identification information. As will be described later, in response to the request from the information acquisition unit 22e to supply confidential information specified in conjunction with the user certificate, the MF apparatus 10 encrypts the confidential information, registered as an entry associated with the user certificate, by means of the user public key included in the user certificate and returns the encrypted confidential information to the information acquisition unit 22e. Therefore, the information acquisition unit 22e acquires the confidential information encrypted by means of the user public key included in the specified user certificate.

The job issuing unit 22f decrypts the encrypted confidential information, acquired by the information acquisition unit 22e, by means of the user private key, registered by the user certificate registration unit 22b, and by means of the decrypted confidential information issues a job to the MF apparatus 10. For example, the job issuing unit 22f transmits a print job to the MF apparatus 10 with the decrypted account-authentication user ID/password attached to the print job. Alternatively, the job issuing unit 22f displays the decrypted fax transmission destination information on the display screen, accepts the specification of a destination number from the user on the display screen, and transmits a direct fax transmission job to the MF apparatus 10 with the specified destination number attached to the direct fax transmission job. To prevent leakage of the confidential information, the job issuing unit 22f encrypts the account-authentication user ID/password or the destination number with the MF public key registered by the MF public key registration unit 22c.

Meanwhile, the MF apparatus 10 has a print engine 11, a facsimile device 12, an MF apparatus storage unit 13, and a controller 14. The print engine 11 is a device that prints an image on a print medium such as paper by means of the xerography method or the ink jet method. The facsimile device 12 is a device that sends or receives image data to or from other facsimile devices. The MF apparatus storage unit 13 includes a volatile storage area allocated in RAM, and a non-volatile storage area allocated on a hard disk. In this embodiment, the non-volatile storage area of the MF apparatus storage unit 13 stores in advance a key pair consisting of the MF public key and the MF private key. The controller 14 controls the entirety of the MF apparatus 10 and manages confidential information. The function of the controller 14 can be configured in one of several ways; in the description below, the function is implemented by executing the predetermined programs on the CPU. The controller 14 has a user certificate registration unit 14a, an information saving unit 14b, an information transmission unit 14c, and a job execution unit 14d.

The user certificate registration unit 14a registers a user certificate. More specifically, the user certificate registration unit 14a receives a user certificate from the PC 20 via the network N and stores the received user certificate in a non-volatile storage area of the MF apparatus storage unit 13. In this embodiment, the user certificate registration unit 14a exchanges a user certificate and an MF public key with the MF public key registration unit 22c of the PC 20.

The information saving unit 14b receives confidential information, transmitted from the information registration unit 22d of the PC 20 in conjunction with the user certificate, and saves the received confidential information and the user certificate in the non-volatile storage area of the MF apparatus storage unit 13 in association with each other. As described above, in this embodiment the confidential information is encrypted by means of the MF public key. The information saving unit 14b may decrypt the encrypted confidential information by means of the MF private key before saving; in this embodiment, the information saving unit 14b stores the encrypted confidential information to thereby ensure security.

In response to a confidential information request, which specifies a user certificate, from the information acquisition unit 22e of the PC 20, the information transmission unit 14c passes the confidential information, saved in the MF apparatus storage unit 13 as an entry associated with the user certificate, to the information acquisition unit 22e. In this embodiment, because the confidential information is saved in a form encrypted by means of the MF public key, the information transmission unit 14c that receives the request decrypts the confidential information, requested by means of the request, by means of the MF private key. Subsequently, the information transmission unit 14c encrypts the decrypted confidential information by means of the user public key included in the specified user certificate and transmits the encrypted confidential information to the information acquisition unit 22e.

In response to a job from the job issuing unit 22f of the PC 20, the job execution unit 14d executes the job. For example, when a print job is received, the job execution unit 14d performs user authentication on the basis of the account-authentication user ID/password and, if the user is authenticated successfully, causes the print engine 11 to execute the job and executes account processing for the user ID; for example, counts the number of prints. Alternatively, in response to a direct fax transmission job, the job execution unit 14d causes the facsimile device 12 to transmit a direct fax to the specified destination number. Because the confidential information, such as the user ID/password or the destination number, is encrypted by means of the MF public key, the job execution unit 14d decrypts the encrypted confidential information by means of the MF private key before executing the job.

The following describes the detailed operation of the image processing system 1 having the above-described configuration. The description is divided into operations performed at the four following times: at the time of information registration, at the time of normal operation (account printing time), at the time of normal operation (direct fax transmission time), and at the time of information update.

A. Processing at Information Registration Time

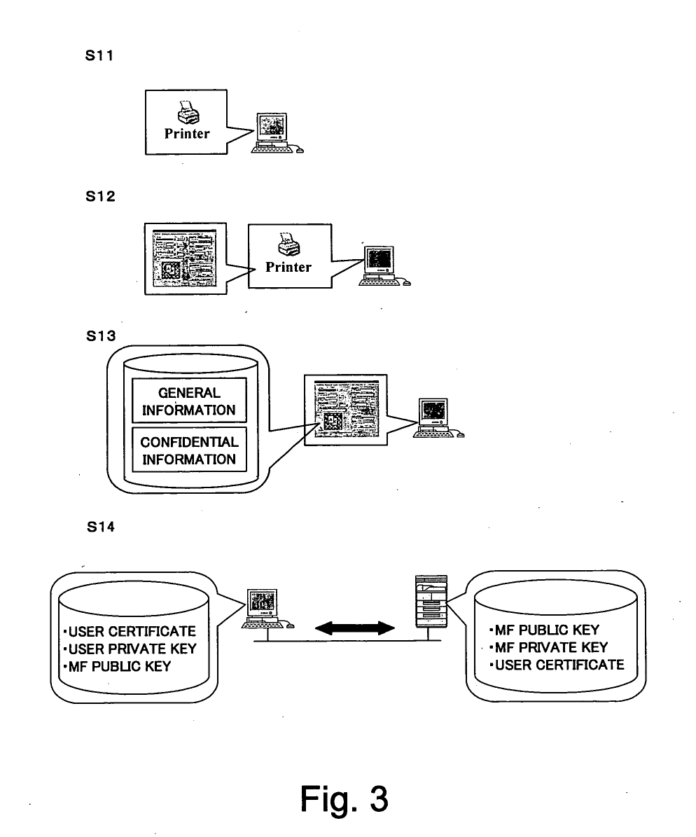

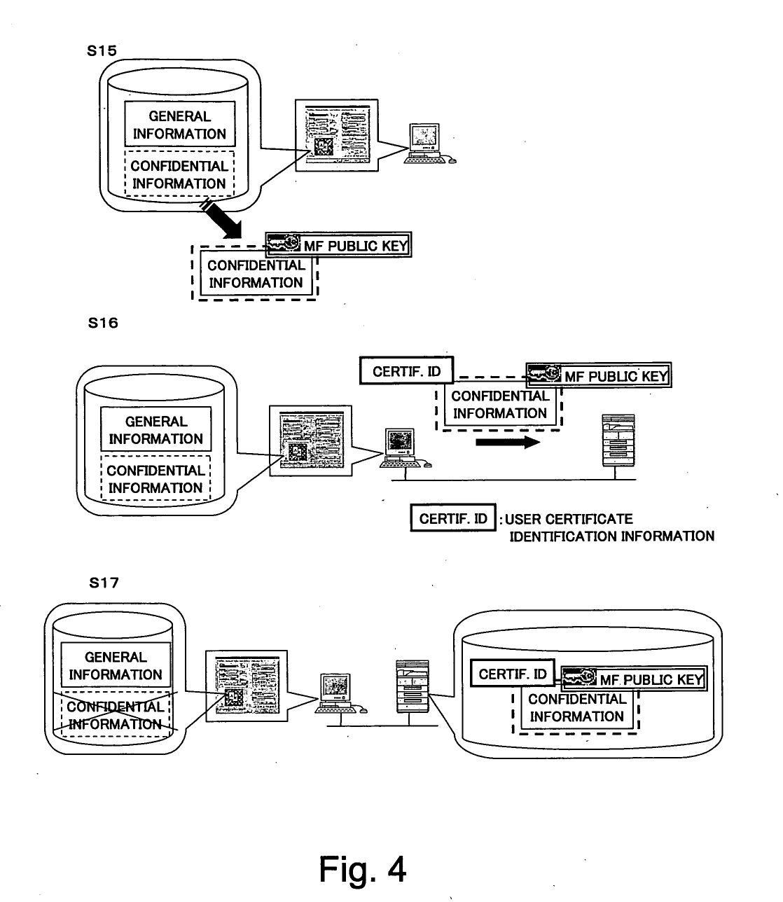

FIGS. 3 and 4 are diagrams showing the operation procedure of the image processing system 1 at the time of information registration. The following describes the operation of the image processing system 1 at the time of information registration with reference to FIGS. 3 and 4. In the description below, note that the device driver is not installed in the PC 20 before the operation is started.

As shown in FIG. 3, in step S11 the device driver corresponding to the MF apparatus 10 is installed in the PC 20.

In step S12, the PC 20 displays a screen for setting the setting information on the basis of the user operation. More specifically, the PC 20 displays the properties screen of the device driver when “Properties” is selected from the right-click menu of the icon of the device driver on the screen.

In step S13, when the properties screen is displayed, the device driver unit 22 creates, in the PC storage unit 21, the data structure of the device driver for storing the setting information. Subsequently, the device driver unit 22 accepts the input of setting information on the basis of the user operation on the properties screen and stores the received setting information in the data structure. The setting information includes general information and confidential information as described above. The confidential information includes account-authentication user ID/password and fax transmission destination information.

In step S14, when a “Register user certificate and MF public key” button is pressed by the user on the properties screen, the device driver unit 22 displays a dialog box for registering the MF public key of the MF apparatus 10 to be associated with the device driver and the user certificate of the user. On the basis of the user operation in the dialog box, the device driver unit 22 registers the user certificate of the user, who uses the device driver and the MF apparatus 10, and the user private key into the PC storage unit 21. Simultaneously, the device driver unit 22 exchanges the user certificate registered as described above and the MF public key with the MF apparatus 10 and registers the MF public key, acquired through the exchange, into the PC storage unit 21. The MF apparatus 10 registers the user certificate, acquired through the exchange described above, into the MF apparatus storage unit 13.

In step S15 in FIG. 4, when the properties screen of the device driver is closed with the user certificate and the MF public key registered in the PC 20, the device driver unit 22 encrypts a part of the data structure of the device driver, created in step S13, that must be made kept secret, by means of the MF public key registered in step S14 described above. That is, the device driver unit 22 encrypts the confidential information by means of the MF public key.

In step S16, the device driver unit 22 transmits to the MF apparatus 10 the confidential information encrypted in step S15 described above, as well as the information (user certificate identification information) identifying the user certificate registered in step S14 described above.

In step S17, when the user certificate identification information and the encrypted confidential information are received from the device driver unit 22, the MF apparatus 10 saves the encrypted confidential information in the MF apparatus storage unit 13 in association with the user certificate identified by the user certificate identification information. Meanwhile, the device driver unit 22 deletes the confidential information from the PC 20 after transmitting the confidential information with the other information (general information) retained in the non-volatile storage area in the PC storage unit 21.

B. Processing at the Time of Normal Operation (Processing at the Time of Account Printing)

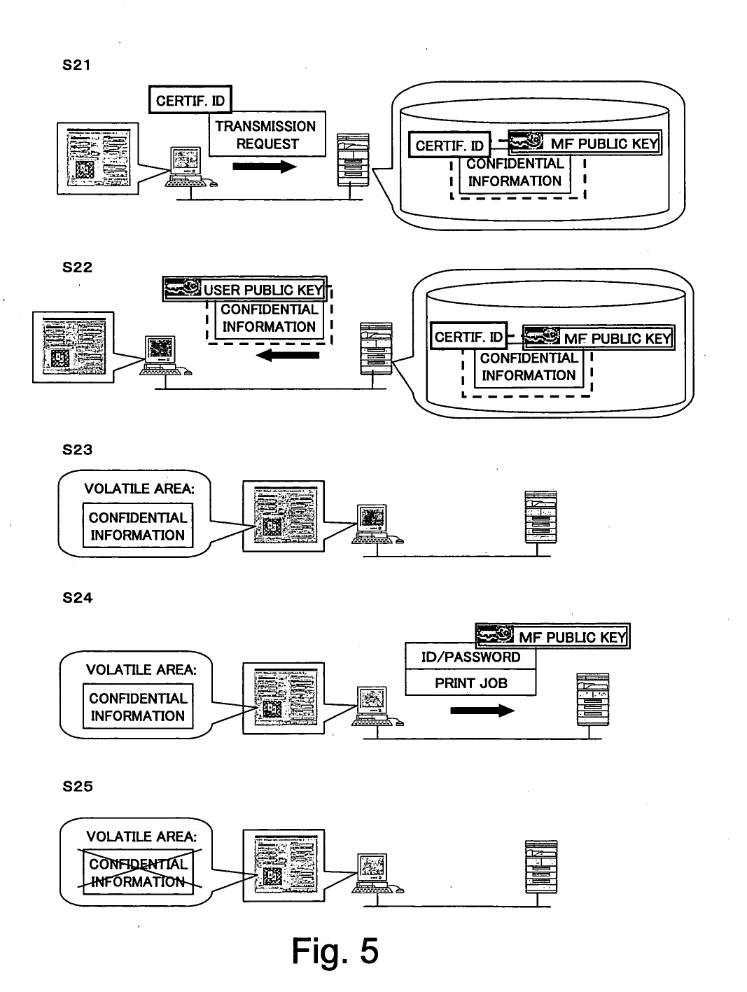

FIG. 5 is a diagram showing the operation procedure of the image processing system 1 at the time of account printing. The following describes the operation of the image processing system 1 at the time of account printing with reference to FIG. 5.

In step S21, when a print instruction is accepted from an application software program, the device driver unit 22 transmits to the MF apparatus 10 a confidential information transmission request, as well as user certificate identification information that identifies a user certificate registered in the PC storage unit 21.

In step S22, upon receipt of the transmission request and the user certificate identification information from the device driver unit 22, the MF apparatus 10 checks if the user certificate identified by the user certificate identification information is registered in the MF apparatus storage unit 13. If the user certificate is found to be registered, the MF apparatus 10 uses the user public key included in the user certificate to encrypt the confidential information, saved as an entry associated with the user certificate identified by the user certificate identification information described above, and returns the encrypted confidential information to the device driver unit 22. If the user certificate is found not to be registered, the MF apparatus 10 returns a message to the device driver unit 22 indicating that the information is not found.

In step S23, the device driver unit 22 receives the encrypted confidential information from the MF apparatus 10 and uses the user private key, registered in the PC storage unit 21, to decrypt the encrypted confidential information in the volatile storage area to thereby make the account-authentication user ID/password available for use.

At this time, if the properties screen of the device driver is open, the device driver unit 22 displays the decrypted confidential information on the properties screen. If the decrypted confidential information contains multiple account-authentication user IDs (that is, multiple account-authentication user IDs are registered for one user), the device driver unit 22 displays the user ID selection dialog box to prompt the user to specify the specification of a user ID which is to be used. If the decrypted confidential information includes only one user ID, the device driver unit 22 may or may not display the confirmation dialog box.

In step S24, the device driver unit 22 attaches the account-authentication user ID/password, determined in step S23 described above, to a print job and transmits the print job to the MF apparatus 10. In this case, before the transmission the device driver unit 22 encrypts at least the account-authentication user ID/password by means of the MF public key registered in the PC storage unit 21.

In step S25, upon receipt of the print job to which the encrypted account-authentication user ID/password is attached, the MF apparatus 10 decrypts the encrypted user ID/password by means of the MF private key registered in the MF apparatus storage unit 13 and authenticates the user on the basis of the decrypted user ID/password. If the user is authenticated successfully, the MF apparatus 10 executes the received print job by means of the print engine 11 and performs account processing for the user ID; for example, counts up the number of prints. If the user authentication fails, the MF apparatus 10 discards the print job and does not execute the printing. In this case, the MF apparatus 10 may send to the device driver unit 22 a message which indicates the failure of user authentication. Meanwhile, after transmitting the print job the device driver unit 22 does not record the confidential information, which was decrypted, expanded, and processed in the volatile storage area of the PC 20, into a non-volatile storage area such as a hard disk, but discards the confidential information from the PC 20.

C. Processing at the Time of Normal Operation (Processing at the Time of Direct Fax Transmission)

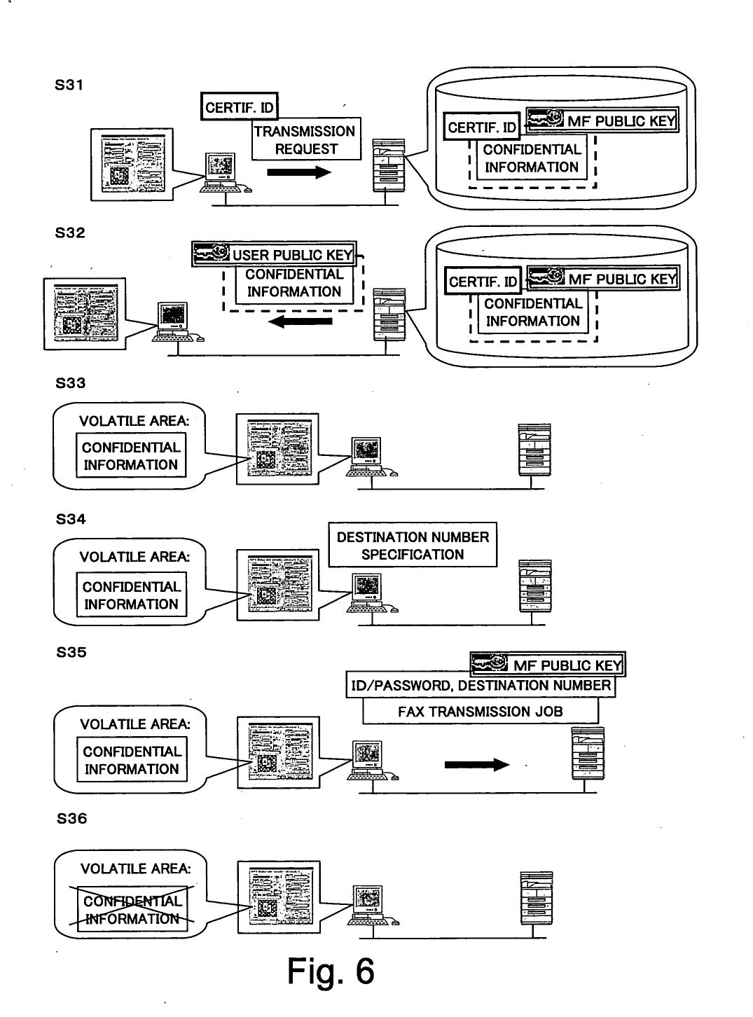

FIG. 6 is a diagram showing the operation procedure of the image processing system 1 at the time of direct fax transmission. The following describes the operation of the image processing system 1 at the time of direct fax transmission.

In step S31, upon acceptance of a direct fax transmission instruction from an application software program, the device driver unit 22 transmits to the MF apparatus 10 a confidential information transmission request, as well as user certificate identification information that identifies the user certificate registered in the PC storage unit 21.

In step S32, upon receipt of the transmission request and the user certificate identification information from the device driver unit 22, the MF apparatus 10 checks if the user certificate identified by the user certificate identification information is registered in the MF apparatus storage unit 13. If the user certificate is found to be registered, the MF apparatus 10 uses the user public key included in the user certificate to encrypt the confidential information, saved as an entry associated with the user certificate identified by the user certificate identification information described above, and returns the encrypted confidential information to the device driver unit 22. If the user certificate is found not to be registered, the MF apparatus 10 returns a message to the device driver unit 22 indicating that the information is not found.

In step S33, the device driver unit 22 receives the encrypted confidential information from the MF apparatus 10 and uses the user private key, registered in the PC storage unit 21, to decrypt the encrypted confidential information in the volatile storage area to thereby make the account-authentication user ID/password and the fax transmission destination information available for use. At this time, if the properties screen of the device driver is open, the device driver unit 22 displays the decrypted confidential information on the properties screen. The device driver unit 22 performs the same account authentication information processing as in step S23 described above.

In step S34, the device driver unit 22 displays a dialog box for specifying a fax transmission destination number and accepts the specification of a destination number from the user through the dialog box. In this dialog box, a list of the destination numbers included in the decrypted fax transmission destination information is displayed so as to allow the user to list and reference the registered destination numbers and specify a desired destination number in the dialog box. In this case, the device driver unit 22 may either limit the specification of a destination number to the numbers included in the decrypted fax transmission destination information and inhibit the user from specifying other destination numbers, or allow the user to specify other destination numbers.

In step S35, the device driver unit 22 attaches to a direct fax transmission job the account-authentication user ID/password, determined in step S33 described above, and the destination number specified in step S34 described above, and transmits the job to the MF apparatus 10. In this case, before the transmission the device driver unit 22 encrypts at least the account-authentication user ID/password and the destination number by means of the MF public key registered in the PC storage unit 21.

In step S36, upon receipt of the direct fax transmission job to which the encrypted account-authentication user ID/password and the destination number are attached, the MF apparatus 10 uses the MF private key registered in the MF apparatus storage unit 13 to decrypt the encrypted user ID/password and the destination number and authenticates the user on the basis of the decrypted user ID/password. If the user is authenticated successfully, the MF apparatus 10 executes the direct fax transmission job by the facsimile device 12 on the basis of the decrypted destination number and performs account processing for the user ID regarding the facsimile transmission. If the user authentication fails, the MF apparatus 10 discards the direct fax transmission job and does not execute the direct fax transmission. In this case, the MF apparatus 10 may send, to the device driver unit 22, a message which indicates the failure of user authentication. Meanwhile, the device driver unit 22 does not record the confidential information, which was decrypted, expanded, and processed in the volatile storage area of the PC 20, into a non-volatile storage area such as a hard disk, but discards the confidential information from the PC 20 after transmitting the job.

D. Processing at the Time of Information Update

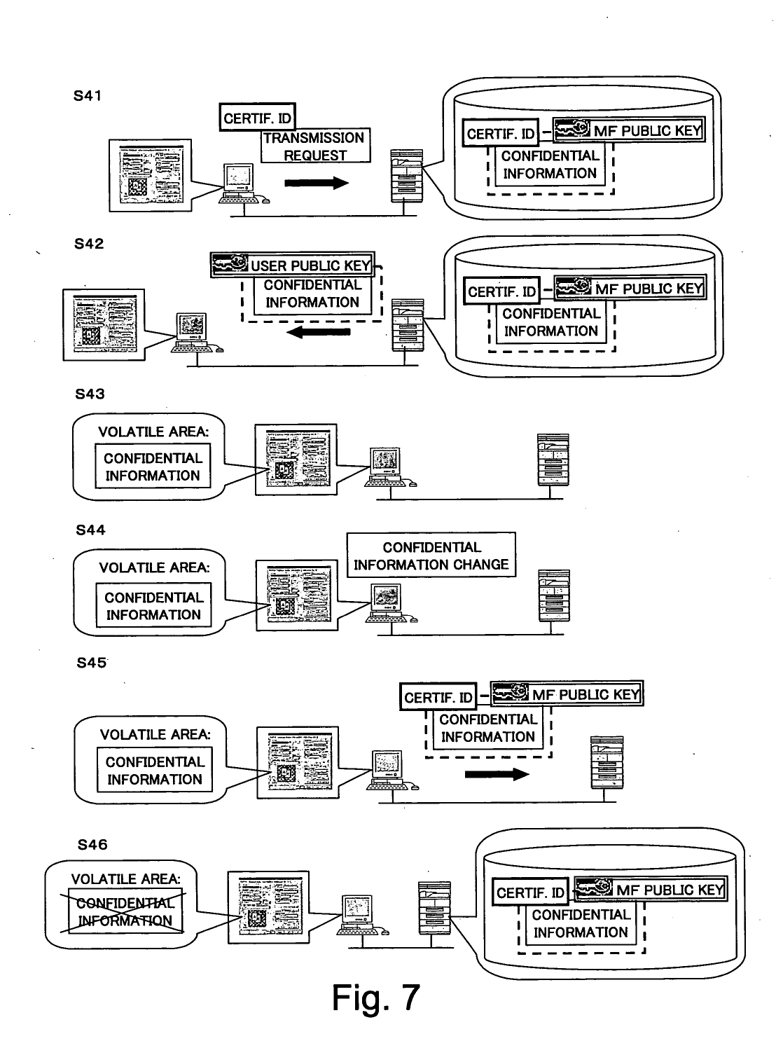

FIG. 7 is a diagram showing the operation procedure of the image processing system 1 at the time of information update. The following describes the operation of the image processing system 1 at the time of information update. Although the following describes only the update of an account-authentication user ID/password, the same operation is used to update other confidential information such as fax transmission destination information.

In step S41, when the user presses the “Add/update account-authentication user ID/password” button on the properties screen of the device driver, the device driver unit 22 displays a dialog box to prompt the user to enter an account-authentication user ID/password. Simultaneously, the device driver unit 22 transmits to the MF apparatus 10 a confidential information transmission request, as well as user certificate identification information that identifies the user certificate registered in the PC storage unit 21.

In step 42, upon receipt of the transmission request and the user certificate identification information from the device driver unit 22, the MF apparatus 10 uses the user public key included in the user certificate to encrypt the confidential information, saved as an entry associated with the user certificate identified by the user certificate identification information described above, and returns the encrypted confidential information to the device driver unit 22.

In step S43, the device driver unit 22 receives the encrypted confidential information from the MF apparatus 10, decrypts the encrypted confidential information in the volatile storage area by means of the user private key registered in the PC storage unit 21, and displays the decrypted account-authentication user ID/password in the dialog box.

In step S44, the device driver unit 22 accepts editing (addition or change) of the account-authentication user ID/password in the dialog box described above and, when the “OK” button is pressed, closes the dialog box.

In step S45, at the same time the dialog box is closed, the device driver unit 22 encrypts the updated account-authentication user ID/password by means of the MF public key registered in the PC storage unit 21 and transmits to the MF apparatus 10 the encrypted account-authentication user ID/password, as well as the user certificate identification information that identifies the user certificate registered in the PC storage unit 21.

In step S46, upon receipt of the user certificate identification information and the encrypted updated account-authentication user ID/password from the device driver unit 22, the MF apparatus 10 writes the encrypted updated account-authentication user ID/password over the confidential information saved as an entry associated with the user certificate identified by the user certificate identification information. Meanwhile, the device driver unit 22 does not record the confidential information, which was decrypted, expanded, and processed in the volatile storage area of the PC 20, into a non-volatile storage area such as a hard disk, but discards the confidential information from the PC 20 after the transmission of the user ID/password.

The image processing system 1 described above may also be configured as described in (a)-(o).

(a) The device driver unit 22 transmits the confidential information to the MF apparatus 10 in step S16 and, subsequently, records information, which indicates that the confidential information is saved in the MF apparatus 10, in the non-volatile storage area of the PC storage unit 21. This information helps the device driver unit 22 to check if the confidential information is registered.

(b) When the user certificate identification information and the encrypted confidential information are received in step S17, the MF apparatus 10 checks if the user certificate identified by the user certificate identification information is already registered in the MF apparatus storage unit 13. If the user certificate is already registered, the MF apparatus 10 saves the encrypted confidential information; if the user certificate is yet not saved, the MF apparatus 10 discards the confidential information and sends a message to the device driver unit 22 to indicate that the user certificate is not saved.

(c) In the PC 20, the device driver unit 22 uses the OS or the application software function supplied with the OS to manage a public key, a private key, and a certificate, or encrypt/decrypt. That is, the OS and the application software supplied with the OS perform key management and encryption/decryption processing, whereas the device driver unit 22 simply calls up the processing.

(d) The device driver unit 22 is configured in such a way that the priority specification of the user ID is accepted on the properties screen. Even if the decrypted confidential information includes multiple account-authentication user IDs/passwords in step S23 but a particular user ID is assigned priority, the device driver unit 22 does not open the user ID selection dialog box but decides to use the priority-assigned user ID.

(e) The device driver unit 22 writes other code over the information when discarding the information from the volatile storage area.

(f) If no user certificate is present in the PC 20 or the public key of the MF apparatus 10 cannot be acquired, the device driver unit 22 does not hold the confidential information, such as a user ID/password, in the non-volatile storage area of the PC 20, but requests the user to enter the confidential information whenever it is required.

(g) If an addition or change to the decrypted confidential information is accepted after transmitting a job, the device driver unit 22 transmits the updated confidential information to the MF apparatus 10 and, after the transmission, discards the confidential information from the volatile storage area as in steps S45-S46.

(h) The device driver unit 22 can acquire confidential information, registered into the MF apparatus 10 by some other PC 20, from the MF apparatus 10 and use the confidential information. For example, the device driver unit 22 has a user interface (UI) that accepts an instruction to use confidential information already registered in the MF apparatus 10 and, if the instruction is accepted, does not register new confidential information. Alternatively, before registering new confidential information, the device driver unit 22 checks if the confidential information associated with the user certificate, registered in the PC storage unit 21, is already registered in the MF apparatus 10. If the confidential information is not yet registered, the device driver unit 22 registers the new confidential information; if the confidential information is already registered, the device driver unit 22 does not register the new confidential information.

(i) When a response indicating that no information is present is received from the MF apparatus 10 in step S22 or S32 described above, the device driver unit 22 notifies the user that the information is not present or is lost. The information is reported, for example, by displaying a confirmation dialog box or by displaying characters or an icon, which indicates that the information is lost, when the properties screen of the device driver is opened.

(j) Upon receipt of a response indicating that the information is not present from the MF apparatus 10 in step S22 or S32 described above, the device driver unit 22 initializes the information, registered in step S14 described above. In this case, the device driver unit 22 may inform the user that the information is initialized.

(k) Upon receipt of a response indicating that the information is not present is received from the MF apparatus 10 in step S22 or S32 described above, the device driver unit 22 does not transmit the job to the MF apparatus 10 but terminates the print processing or the direct fax transmission processing.

(l) Upon receipt of a response indicating that the information is not present from the MF apparatus 10 in step S22 or S32 described above, the device driver unit 22 displays a dialog box, which requests the user to enter confidential information such as an account-authentication user ID/password or fax transmission destination information, and transmits the job to the MF apparatus 10 on the basis of the information entered through the dialog box. In this case, the device driver unit 22 may transmit the entered confidential information to the MF apparatus 10 for registration therein.

(m) The MF apparatus 10 identifies the PC 20 that first registered confidential information and rejects and discards update information received from a PC other than that PC 20.

(n) The ME apparatus 10 validates a user on the basis of a user certificate upon receipt of the user certificate from the device driver unit 22 in step S14.

(o) The MF apparatus 10 transmits an MF certificate, which includes the MF public key, to the device driver unit 22 in step S14. The device driver unit 22 validates the MF apparatus 10 on the basis of the MF certificate when the MF certificate is received from the MF apparatus 10.

Although embodiments of the present invention have been described with a certain degree of particularity using specific examples, it is to be understood that the invention is not limited thereto. It is further understood by those skilled in the art that various changes and modifications may be made to the invention without departing from the spirit and scope thereof.

For example, the confidential information may be other information such as confidential-print (security-print) user ID/password. The following briefly describes confidential printing. To perform confidential printing, the device driver unit 22 transmits a confidential-print job to the MF apparatus 10 in accordance with an instruction from the user. In this case, a confidential-print user ID/password is attached to the confidential-print job. The MF apparatus 10 receives the job and temporarily saves it therein. Subsequently, the MF apparatus 10 receives a user ID/password from the user and, if a confidential-print job to which the received user ID/password is attached is saved, executes the confidential-print job.

Although in the above embodiment the device driver unit 22 transmits a confidential information transmission request to the MF apparatus 10 upon receipt of a print instruction or a direct fax transmission instruction, the device driver unit 22 may transmit a transmission request at some other time. For example, the device driver unit 22 may transmit a transmission request at one of the following times: when device driver information is referenced, when power is turned on, when the PC 20 is reset, when a user logs on, when the mode is returned from power-saving mode or sleep mode, or when a user directly specifies an instruction to acquire information.

What is claimed is:

1. An image processing system comprising:
an image processing device that processes an image;
an information registration unit that transmits to the image processing device confidential information, included in setting information used for issuing a job, and registers the confidential information therein;
an information acquisition unit that, before issuing a job, requests the image processing device to send the registered confidential information and acquires the confidential information; and
a job issuing unit that issues the job to the image processing device using the acquired confidential information.

2. The image processing system according to claim 1, wherein
the image processing device transmits and receives the confidential information via encrypted communication.

3. An image processing system comprising:
an image processing device that processes an image;
a user certificate registration unit that registers a user certificate and a private key;
an information registration unit that transmits to the image processing device confidential information, included in setting information used for issuing a job, to cause the confidential information to be registered in the image processing device, in association with the user certificate;
an information acquisition unit that, before issuing a job, requests the image processing device to send the confidential information by specifying the user certificate, and acquires the confidential information which is encrypted by means of a public key included in the user certificate; and
a job issuing unit that decrypts the acquired and encrypted confidential information by means of the registered private key and issues the job to the image processing device using the decrypted confidential information.

4. The image processing system according to claim 3, further comprising
a public key registration unit that registers a public key of the image processing device, wherein;
the confidential information is encrypted by means of the public key registered by the public key registration unit and transmitted to the image processing device, and
the encrypted and transmitted confidential information is decrypted by means of a private key of the image processing device registered in the image processing device.

5. An information processing device that issues a job to an image processing device, comprising:
an information registration unit that transmits confidential information, included in setting information used for issuing a job, to the image processing device and registers the confidential information therein;
an information acquisition unit that, before issuing a job, requests the image processing device to send the registered confidential information and acquires the confidential information; and
a job issuing unit that issues a job to the image processing device using the acquired confidential information.

6. An information processing device that issues a job to an image processing device, comprising:
a user certificate registration unit that registers a user certificate and a private key;
an information registration unit that transmits confidential information, included in setting information used for issuing a job, to the image processing device to cause the confidential information to be registered in the image processing device, associated with the user certificate;
an information acquisition unit that, before issuing a job, requests the image processing device to send the confidential information by specifying the user certificate, and acquires the confidential information which is encrypted by means of a public key included in the user certificate; and
a job issuing unit that decrypts the acquired and encrypted confidential information by means of the registered private key and issues the job to the image processing device using the decrypted confidential information.

7. The information processing device according to claim 6, further comprising a public key registration unit that registers a public key of the image processing device, wherein:
the confidential information is encrypted by means of the public key registered by the public key registration unit and transmitted to the image processing device.

8. The information processing device according to claim 6, wherein
the information processing device is configured to acquire confidential information which is registered by other information processing devices from the image processing device and use the acquired information.

9. The information processing device according to claim 7, wherein
the information processing device is configured to acquire confidential information which is registered by other information processing devices from the image processing device and use the acquired information.

10. A storage medium readable by a computer, the storage medium storing a program of instructions executable by the computer to perform a function for issuing a job to an image processing device, the function comprising:
transmitting confidential information, included in setting information used for issuing a job, to the image processing device and registering the confidential information therein;
before issuing a job, requesting the image processing device to send the registered confidential information and acquiring the confidential information; and
issuing the job to the image processing device by use of the acquired confidential information.

11. A storage medium readable by a computer, the storage, medium storing a program of instructions executable by the computer to perform a function for issuing a job to an image processing device, the function comprising:
registering a user certificate and a private key;
transmitting confidential information, included in setting information used for issuing a job, to the image processing device and registering the confidential information therein associated with the user certificate;
before issuing a job, requesting the image processing device to send the confidential information by specifying the user certificate;
acquiring the requested confidential information which is encrypted by means of a public key included in the user certificate; and
decrypting the acquired and encrypted confidential information by means of the registered private key and issuing the job to the image processing device by use of the decrypted confidential information.

12. The storage medium readable by a computer according to claim 11, the function further comprising
registering a public key of the image processing device, wherein
the confidential information is encrypted by means of the registered public key and is transmitted to the image processing device.

13. The storage medium readable by a computer according to claim 11, wherein
the function allows an information processing device to acquire from the image processing device confidential information which is registered by other information processing device, and use the acquired information.

14. The storage medium readable by a computer according to claim 12, wherein
the function allows an information processing device to acquire from the image processing device confidential information which is registered by other information processing device, and use the acquired information.

15. An information processing method for issuing a job to an image processing device, comprising:
transmitting to the image processing device confidential information, included in setting information used for issuing a job, and registering the confidential information therein;
before issuing a job, requesting the image processing device to send the registered confidential information and acquiring the confidential information; and
issuing the job to the image processing device by use of the acquired confidential information.

16. An information processing method for issuing a job to an image processing device, comprising:
registering a user certificate and a private key;
transmitting to the image processing device confidential information, included in setting information used for issuing a job, and registering the confidential information therein in association with the user certificate;
before issuing a job, requesting the image processing device to send the confidential information by specifying the user certificate;
acquiring the requested confidential information which is encrypted by means of a public key included in the user certificate; and
decrypting the acquired and encrypted confidential information by means of the registered private key and issuing the job to the image processing device by use of the decrypted confidential information.

17. The information processing method according to claim 16, further comprising registering a public key of the image processing device, wherein;
the confidential information is encrypted by means of the registered public key and is transmitted to the image processing device.
